(19) United States
(12) Patent Application Publication
(10) Pub. No.: US 2008/0247304 A1
(43) Pub. Date: Oct. 9, 2008

(54) INFORMATION RECORDING MEDIUM

(75) Inventors: Kazuyo Umezawa, Yokohama-shi (JP); Seiji Morita, Yokohama-shi (JP); Koji Takazawa, Hino-shi (JP); Hideo Ando, Hino-shi (JP); Naomasa Nakamura, Yokohama-shi (JP); Naoki Morishita, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/021,126

(22) Filed: Jan. 28, 2008

(30) Foreign Application Priority Data
Jan. 30, 2007 (JP) 2007020015

(51) Int. Cl. G11B 7/26

(52) U.S. Cl. 369/277

(57) ABSTRACT

According to one embodiment, when recording information by using a semiconductor laser at 450 nm or less, an information recording medium satisfies

9.5×10⁻⁸≧λ/(X*NA)≧4.6×10⁻⁸

(where X is the linear recording velocity, λ is the laser wavelength, and NA is the numerical aperture).

### CROSS-REFERENCE TO RELATED APPLICATIONS

This application is based upon and claims the benefit of priority from Japanese Patent Application No. 2007-020015, filed Jan. 30, 2007, and Japanese Patent Application No. 2008-017028, filed Jan. 29, 2008, the entire contents of which are incorporated herein by reference.

### BACKGROUND OF THE INVENTION

1. Field of the Invention

One embodiment of the present invention relates to an information recording medium, particularly, a write-once information recording medium capable of information recording/playback by a short-wavelength laser beam such as a blue laser beam.

The present invention also relates to an information recording medium capable of information recording at a high transfer rate.

2. Description of the Related Art

Optical disks are roughly classified into three types: a ROM disk as a read-only disk, a write-once R disk, and a rewritable RW or RAM disk. As the volume of information increases, demands have arisen for increasing the capacity and transfer rate of optical disks. A CD and DVD are examples of presently commercially available optical disks. To meet the market demands for shortening the recording time of recordable optical disks, the transfer rates of, e.g., a CD-R and DVD-R have been respectively increased by 48 times and 16 times.

To further increase the capacity of an optical disk, an optical disk called an HD DVD has been developed. An HD DVD-ROM and HD DVD-R have a data capacity of 15 GB on one side. This data capacity is larger than the triple of 4.7 GB as the capacity of the conventional DVD. It is disclosed by, for example, Jpn. Pat. Appln. KOKAI Publication No. 2006-205683 and Jpn. Pat. Appln. KOKAI Publication No. 2005-271587, an organic dye material is used in the recording layer of this HD DVD-R.

Presently, however, the HD DVD can record information at only a standard velocity.

When information is recorded at a high linear velocity on the HD DVD-R disk capable of recording at the standard velocity, the recording signal characteristics considerably degrade even if the recording velocity is a double velocity. This makes it difficult to perform high-linear-velocity recording with the present recording layer characteristics.

### SUMMARY OF THE INVENTION

Accordingly, it is an object of the present invention to provide an information recording medium capable of recording/playback at a high linear velocity by using light having a wavelength of 450 nm or less without degrading the recording signal characteristics.

In accordance with this object, the present invention includes an information recording medium comprising a transparent resin substrate on which grooves and lands having a concentric shape or a spiral shape are formed, and a recording layer formed on the grooves and the lands of the transparent resin substrate, the information recording medium being configured to record and play back information by using a laser at not more than 450 nm, wherein the recording medium is configured such that information recording is performed to substantially satisfy the expression 9.5×10⁻⁸≧λ/(X*NA)≧4.6×10⁻⁸, where X is a linear recording velocity, λ is the laser wavelength, and NA is a numerical aperture. By this invention, it is still possible to keep good quality of recording/playback not only at a normal linear velocity but at a high linear velocity without degrading the recording signal characteristics, using the information recording medium being configured to record and play back information by using a laser having the wavelength of 450 nm or less. Other objects and advantages of the invention will be readily apparent from the following detailed discussion.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a graph showing the relationship between the ratio of the one-times-velocity recording power to the two-times-velocity recording power and the SbER at each linear velocity;

FIG. 2 is a view for explaining an example of the arrangement of an optical disk according to an embodiment of the present invention;

FIG. 3 is a view for explaining an example of the arrangement of a physical format according to the embodiment of the present invention;

FIG. 4 is a view showing examples of organic dye materials usable as an L-to-H organic dye layer;

FIGS. 5A to 5C are graphs each showing the relationship between the laser beam wavelength and the absorbance of a dye;

FIGS. 6A and 6B are graphs each showing the relationship between the laser beam wavelength and the absorbance of a dye;

FIG. 7 is a timing chart showing a method of recording rewritable data to be recorded on a write-once information storage medium; and

FIG. 8 is a timing chart showing a method of recording rewritable data to be recorded on a write-once information storage medium at a two-times velocity or more.

### DETAILED DESCRIPTION OF THE PREFERRED EMBODIMENT

Various embodiments according to the invention will be described hereinafter with reference to the accompanying drawings. The present inventors have made extensive studies to solve the above problems, and found that when recording and playback are performed on a single-layer disk, the recording characteristics at a high linear velocity degrade if a recording layer containing a dye material with which a slight mark distortion is observed from an electrical signal is used, and it is possible to obtain good recording characteristics at not only a standard velocity but also a high linear velocity by using a recording layer containing a dye material with which almost no mark distortion is observed.

The reason why the recording characteristics at a high linear velocity degrade when a recording layer containing a dye material that produces mark distortion is used is probably as follows. A recording layer containing a dye material that produces mark distortion requires an energy amount larger than that required by a dye material that hardly produces distortion during recording, and this presumably causes deformation (a physical change) in the interface between the dye and a polycarbonate substrate. An L-to-H dye (by which the reflectance rises after recording) normally capable of recording at 450 nm or less changes its three-dimensional structure during recording, and this probably changes the optical characteristics. The time required for this three-dimensional structural change of the dye is less than that required for the deformation of the polycarbonate substrate. Also, heat control on the recording film during recording becomes difficult when the linear velocity rises. From the foregoing, a dye that produces mark distortion presumably degrades the recording characteristics at a high linear velocity. When the recording film surface of a disk 100 that produced recording distortion was actually observed with an SEM, the surface after recording was rougher than that before recording, indicating that deformation (a physical change) probably occurred due to recording in the interface between the recording layer and polycarbonate substrate.

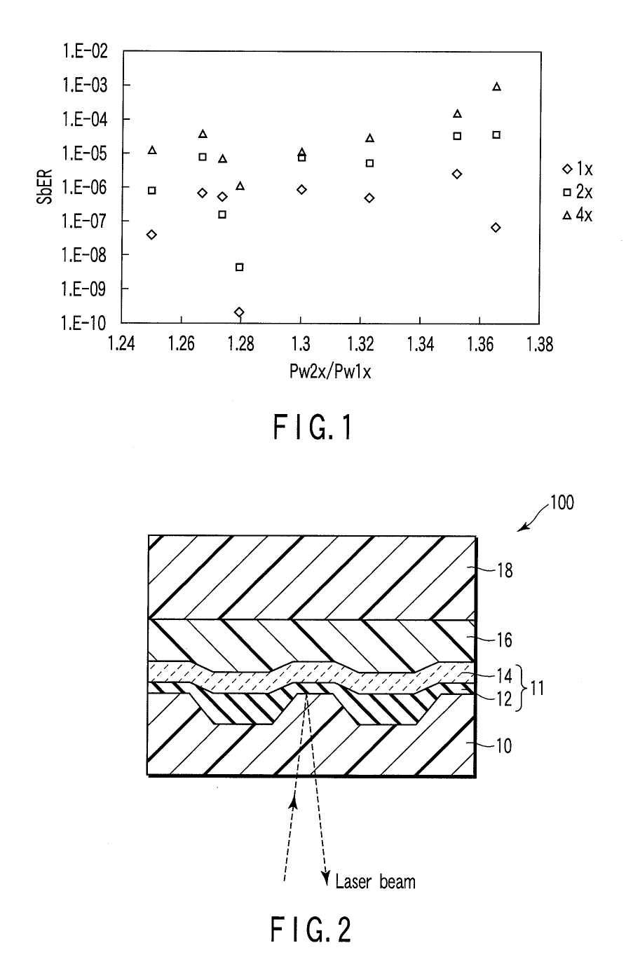

In an information recording medium in which the physical change such as deformation is large, a high recording power is presumably necessary especially in high-linear-velocity recording. In particular, as the difference between the recording power at a one-times velocity and that at a two-times velocity increases, the difficulty of recording at a high linear velocity increases. FIG. 1 shows the results of examination the present inventors made on various dyes. FIG. 1 is a graph showing the relationship between the ratio of the one-times-velocity recording power to the two-times-velocity recording power and the SbER at each linear velocity. Referring to FIG. 1, rhombs, squares, and triangles respectively indicate the one-times velocity, two-times velocity, and four-times velocity. FIG. 1 shows that when an information recording medium in which the Pw2×/Pw1× was 1.35 or less was used, good recording characteristics were obtained up to at least the four-times velocity.

On the other hand, when the recording film surface of the disk 100 using a recording layer that produced almost no mark distortion was observed with an SEM, the surface was flat even after recording. Accordingly, to obtain an information recording medium capable of high-linear-velocity recording while maintaining good recording characteristics, it is favorable to use a recording layer that hardly produces mark distortion during recording.

According to the preferred embodiment of this invention, the information recording medium is configured such that information recording is performed to substantially satisfy the following expression

9.5×10⁻⁸≧λ/(X*NA)≧4.6×10⁻⁸ (1)

where X is a linear recording velocity, λ is the laser wavelength, and NA is a numerical aperture. The λ/(X*NA) represents the time during which a laser spot passes through a certain point on an optical disk. The smaller the value of λ/(X*NA), the higher the recording velocity. Assuming that laser wavelength λ=405 nm and numeral aperture NA=0.65, for example, times λ/(X*NA) are 9.4×10⁻⁸, 4.6×10⁻⁸, and 2.4×10⁻⁸ when the linear recording velocities X are 6.63, 13.50, and 25.96 m/s, respectively. The present invention can hold favorable recording characteristics by satisfying the above relation.

Also, letting X be the linear recording velocity, λ be the laser wavelength, and NA be the numerical aperture, the information recording medium according to the present invention can satisfy

9.5×10⁻⁸≧λ/(X*NA)≧2.3×10⁻⁸ (2)

when recording information, in order to further increase the linear recording velocity.

In the present invention, an organic dye material to be used can be selected so as to satisfy the above conditions and obtain a recording layer that produces almost no mark distortion. An organic dye material can be used as the material of a recording layer formed in the information recording medium according to the present invention. Also, an organic metal complex can be used as this organic dye material. It is possible to use, e.g., an azo organic metal complex as this material.

When the UV spectrum of the recording layer was measured before and after recording, a maximum absorption wavelength near the recording laser wavelength shifted to the short-wavelength side by a few ten nm after recording. Accordingly, the information recording medium according to the present invention can be an information recording medium which uses an organic dye material as the material of the recording layer, and in which a maximum absorption wavelength of the organic dye before recording exists within the range of −10 to +50 nm from the recording laser wavelength. It is preferable to use an organic dye with which a maximum absorption wavelength of the UV spectrum of the dye recording film after recording shifts by 5 to 30 nm to the short-wavelength side from that before recording.

The information recording medium preferably has a predetermined area containing recording parameters, and maximum values of the recording power at least the standard velocity (one-times velocity) and two-times velocity of linear recording velocities are preferably described in this area. This can help determine the recording power when actually recording information in the drive.

In addition, as is apparent from FIG. 1, in the information recording medium according to the present invention, the relationship between the recording power (Pw1×) when information is recorded at the standard velocity and the recording power (Pw2×) when information is recorded at the two-times velocity can be set to satisfy:

Pw2×/Pw1×<1.35 (3)

FIG. 2 is a view for explaining the arrangement of a write-once, single-layer optical disk 100 as an example of an optical disk according to an embodiment of the present invention. As shown in FIG. 2, the optical disk 100 has a transparent resin substrate 10 formed into a disk-like shape by using a synthetic resin material such as polycarbonate (PC). Concentric or spiral grooves are formed in the transparent resin substrate 10. The transparent resin substrate 10 can be manufactured by injection molding by using a stamper.

A recording layer 11 including an organic dye layer 12 and a light-reflecting layer 14 made of, e.g., silver or a silver alloy is stacked on the 0.60-mm-thick transparent resin substrate 10 made of, e.g., polycarbonate. A 0.60-mm-thick transparent resin substrate 18 is adhered by using an UV-curing resin (adhesive layer) 16. The total thickness of the laminated optical disk thus formed is about 1.2 mm.

Spiral grooves having a depth of, e.g., 60 nm are formed at a track pitch of, e.g., 0.4 pm in the transparent resin substrate 10. The grooves wobble, and address information is recorded on the wobble.

The recording layer 12 containing an organic dye is formed on the transparent resin substrate 10 so as to fill the grooves. As the organic dye forming the recording layer 12, it is possible to use a material whose maximum absorption wavelength region has shifted to the long-wavelength side from the recording wavelength (e.g., 405 nm). Also, the organic dye is designed such that absorption does not disappear in the recording wavelength region, but considerable light absorption occurs in the long-wavelength region (e.g., 450 to 600 nm).

It is readily possible to spin-coat the transparent resin substrate surface with a liquid prepared by dissolving the organic dye in a solvent. In this case, the film thickness can be precisely managed by controlling the ratio of dilution by the solvent, and the rotational velocity of spin coating.

Note that the recording layer 11 herein used has a low light reflectance when a track is focused or tracked by a recording laser beam before information recording. After that, the laser beam causes some optical change of the dye and decreases the light absorptance, thereby raising the light reflectance of a recording mark portion. This implements so-called Low-to-High (or L-to-H) characteristics by which the light reflectance of a recording mark portion formed by irradiation with a laser beam is higher than that before laser beam irradiation.

Note that the heat generated by irradiation with the recording laser sometimes deforms the transparent resin substrate 10, particularly, the groove bottom portion. In this case, a phase difference may be produced in laser reflected light upon playback after recording (when compared to the case where no thermal deformation occurs). However, the problem of this phase difference production can be suppressed or avoided by suppressing or preventing the deformation of the recording mark by the embodiment of the present invention.

An example of a physical format applied to the transparent resin substrate 10 in the embodiment of the present invention is as follows. The recording capacity usable by the user is 15 GB.

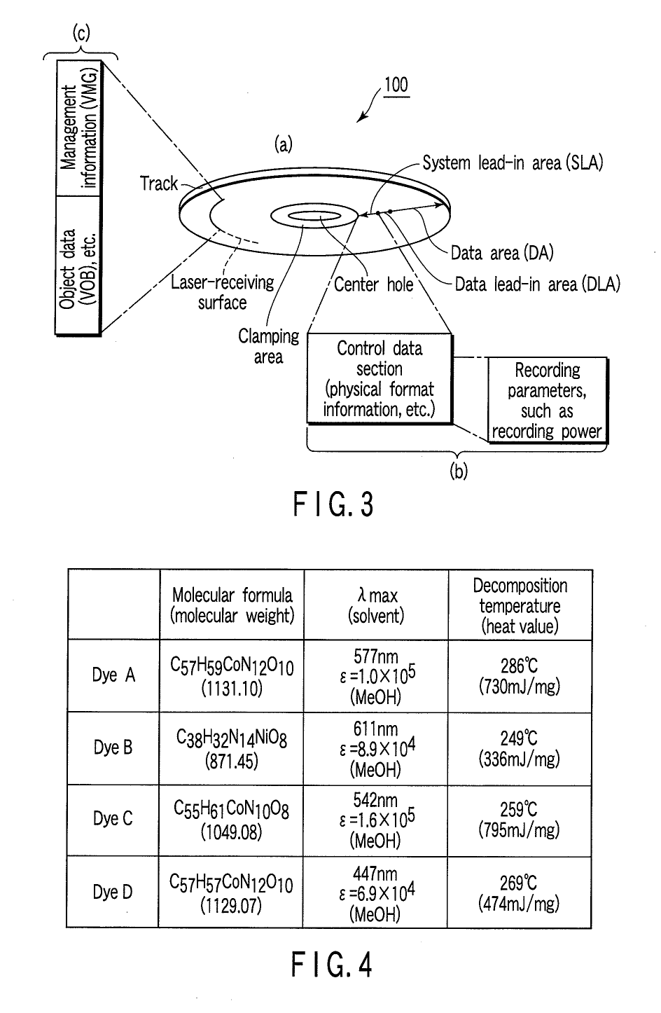

In the optical disk 100 shown in (a) of FIG. 3, a system lead-in area SLA includes a control data section as shown in (b) of FIG. 3. This control data section contains recording parameters, such as the recording power (peak power), as a part of the physical format information and the like. The control data section also contains information of the recording power at each linear recording velocity. The system lead-in area SLA is preformed on the transparent resin substrate 10.

A laser having a predetermined recording power (peak power) and bias power performs mark/space recording on tracks in a data area DA of the optical disk 100. As shown in (c) of FIG. 3, this mark/space recording records object data (e.g., VOB) of a high-resolution TV broadcasting program or the like, and management information (VMG) of the object data, on the tracks in the data area DA.

As the L-to-H organic dye usable in the embodiment of the present invention, it is possible to use an organic dye including a dye portion and counterion (anion) portion, or an organic metal complex. As the dye portion, it is possible to use, e.g., a cyanine dye, styryl dye, porphyrin-based dye, or azo dye. A cyanine dye, styryl dye, and azo dye are particularly favorable because the absorptance to the recording wavelength is readily controllable.

Of the L-to-H organic dyes, a monomethinecyanine dye having a monomethine chain makes it possible to readily adjust a maximum absorption and the absorbance in the recording wavelength region (400 to 405 nm) to, e.g., about 0.3 to 0.5, preferably, about 0.4, by coating the transparent resin substrate with a thin recording film. This makes it possible to improve the recording/playback characteristics, and favorably design both the light reflectance and recording sensitivity.

The anion portion of the organic dye is preferably an organic metal complex from the viewpoint of optical stability as well. An organic metal complex containing cobalt or nickel as the central metal is particularly superior in optical stability.

An example of the organic metal complex is an azo metal complex. The solubility of the azo metal complex is high when 2,2,3,3-tetrafluoro-1-propanol (TFP) is used as a solvent, so a solution for spin coating can be easily prepared. It is also possible to reduce the manufacturing cost of the information recording medium because recycling after spin coating is possible.

Note that the organic metal complex can be dissolved in TFP, and the solution can be spin-coated. In particular, the azo metal complex hardly deforms after recording. When used in an information recording medium having two recording layers, therefore, the azo metal complex is favorably used in an LO recording layer having a thin Ag alloy layer. As the central metal, it is possible to use Cu, Ni, Co, Zn, Fe, Al, Ti, V, Cr, or Y. Cu, Ni, and Co are particularly superior in playback light resistance, and Cu has no genotoxicity and improves the quality of recording/playback signals.

Various materials can be used as a ligand surrounding the central metal. Examples are dyes represented by formulas (D1) to (D6) below. It is also possible to form another structure by combining these liqands.

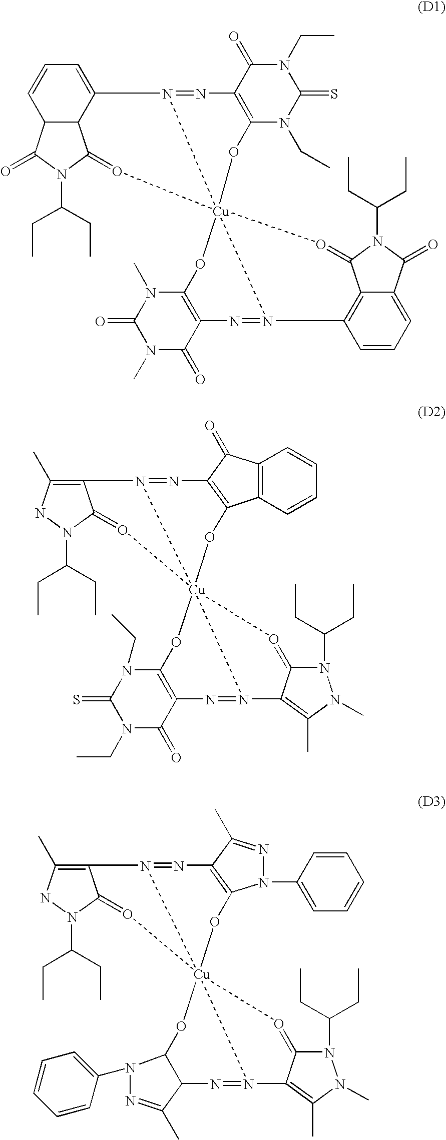

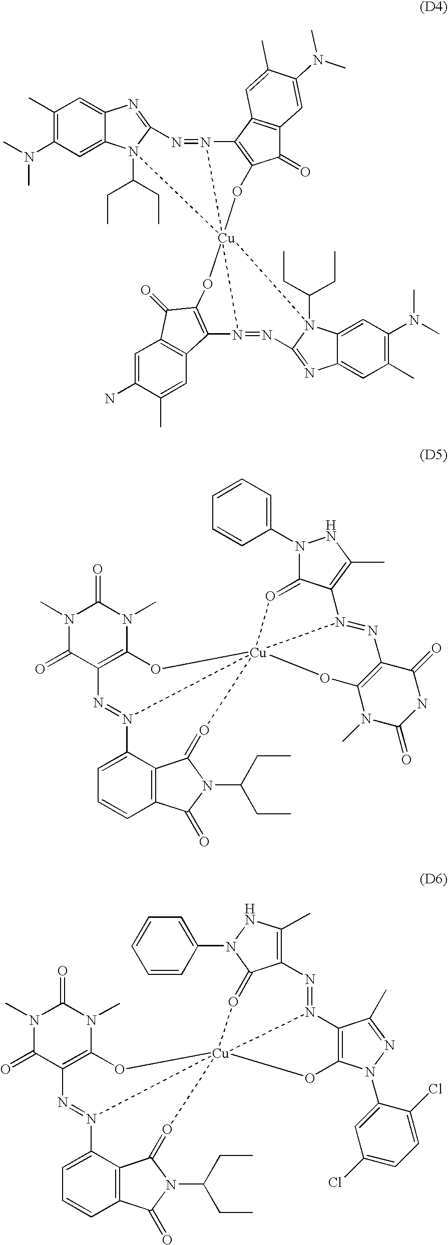

FIG. 4 shows dyes A to D as four examples of the organic dye material usable in the L-to-H organic dye layer usable in the present invention. Dye A has a styryl dye as the dye portion (cation portion), and azo metal complex 1 as the anion portion. Dye C has a styryl dye as the dye portion (cation portion), and azo metal complex 2 as the anion portion. Dye D has a monomethinecyanine dye as the dye portion (cation portion), and azo metal complex 1 as the anion portion. Note that the organic metal complex may also be used alone. Dye B is, e.g., a nickel complex dye.

Formula (E1) below indicates the formula of the styryl dye as the dye portions of dyes A and C. Formula (E2) below indicates the formula of the azo metal complex as the anion portions of dyes A and C. Formula (E3) below indicates the formula of the monomethinecyanine dye as the dye portion of dye D. Formula (E4) below indicates the formula of the azo metal complex as the anion portion of dye D.

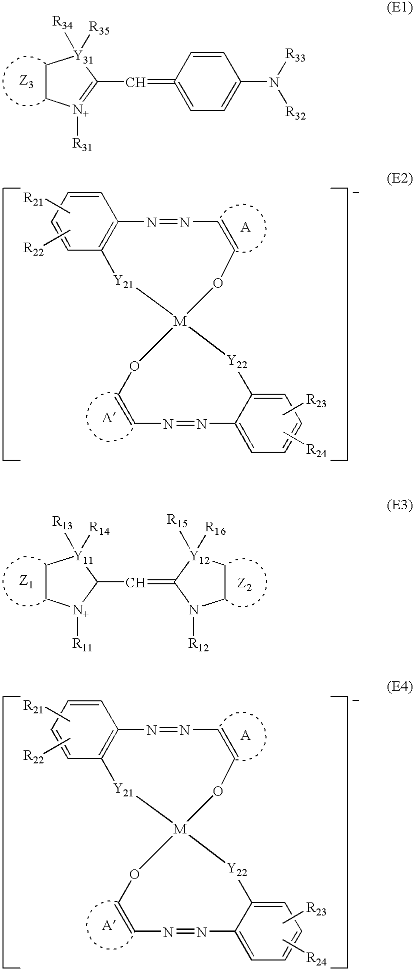

In the formula of the styryl dye, Z3 represents an aromatic ring, and this aromatic ring may have a substituent group. Y31 represents a carbon atom or hetero atom. R31, R32, and R33 represent the same aliphatic hydrocarbon group or different aliphatic hydrocarbon groups, and these aliphatic hydrocarbon groups may have a substituent group. R34 and R35 each independently represent a hydrogen atom or an appropriate substituent group. When Y31 is a hetero atom, one or both of R34 and R35 do not exist.

In the formula of the monomethinecyanine dye, Z1 and Z2 represent the same aromatic ring or different aromatic rings, and these aromatic rings may have a substituent group. Y11 and Y12 each independently represent a carbon atom or hetero atom. R11 and R12 represent aliphatic hydrocarbon groups, and these aliphatic hydrocarbon groups may have a substituent group. R13, R14, R15, and R16 each independently represent a hydrogen atom or an appropriate substituent group. When Y11 and Y12 are hetero atoms, some or all of R13, R14, R15, and R16 do not exist.

An example of the monomethinecyanine dye used in this embodiment is a dye obtained by bonding cyclic nuclei that may have one or a plurality of substituent groups and may be the same or different to the two ends of a monomethine chain that may have one or a plurality of substituent groups. Examples of the cyclic nuclei are an imidazoline ring, imidazole ring, benzoimidazole ring, α-naphthoimidazole ring, β-naphthoimidazole ring, indole ring, isoindole ring, indolenine ring, isoindolenine ring, benzoindolenine ring, pyridinoindolenine ring, oxazoline ring, oxazole ring, isoxazole ring, benzoxazole ring, pyridinoxazole ring, α-naphthoxazole ring, β-naphthoxazole ring, selenazoline ring, selenazole ring, benzoselenazole ring, α-naphthoselenazole ring, β-naphthoselenazole ring, thiazoline ring, thiazole ring, isothiazole ring, benzothiazole ring, α-naphthothiazole ring, β-naphthothiazole ring, tellurazoline ring, tellurazole ring, benzotellurazole ring, β-naphthotellurazole ring, β-naphthotellurazole ring, acridine ring, anthracene ring, isoquinoline ring, isopyrrole ring, imidanoxaline ring, indandione ring, indazole ring, indaline ring, oxadiazole ring, carbazole ring, xanthene ring, quinazoline ring, quinoxaline ring, quinoline ring, chroman ring, cyclohexanedione ring, cyclopentanedione ring, cinnoline ring, thiodiazole ring, thioxazolidone ring, thiophene ring, thionaphthene ring, thiobarbituric acid ring, thiohydantoin ring, tetrazole ring, triazine ring, naphthalene ring, naphthyridine ring, piperazine ring, pyrazine ring, pyrazole ring, pyrazoline ring, pyrazolidine ring, pyrazolone ring, pyran ring, pyridine ring, pyridazine ring, pyrimidine ring, pyrylium ring, pyrrolidine ring, pyrroline ring, pyrrole ring, phenazine ring, phenanthridine ring, phenanthrene ring, phenanthroline ring, phthalazine ring, pteridine ring, furazane ring, furan ring, purine ring, benzene ring, benzoxazine ring, benzopyran ring, morpholine ring, and rhodanine ring.

Throughout the formulas of the monomethinecyanine dye and styryl dye, Z1 to Z3 represent aromatic rings such as a benzene ring, naphthalene ring, pyridine ring, quinoline ring, and quinoxaline ring, and these aromatic groups may have one or a plurality of substituent groups. Examples of the substituent groups are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tertpentyl group, 1-methylpentyl group, 2-methylpentyl group, hexyl group, isohexyl group, 5-methylhexyl group, heptyl group, and octyl group, alicyclic hydrocarbon groups such as a cyclopropyl group, cyclobutyl group, cyclopentyl group, and cyclohexyl group, aromatic hydrocarbon groups such as a phenyl group, biphenyl group, o-tolyl group, m-tolyl group, p-tolyl group, xylyl group, mesityl group, o-cumenyl group, m-cumenyl group, and p-cumenyl group, ether groups such as a methoxy group, trifluoromethoxy group, ethoxy group, propoxy group, isopropoxy group, butoxy group, sec-butoxy group, tert-butoxy group, pentyloxy group, phenoxy group, and benzoyloxy group, ester groups such as a methoxycarbonyl group, trifluoromethoxycarbonyl group, ethoxycarbonyl group, propoxycarbonyl group, acetoxy group, and benzoyloxy group, halogen groups such as a fluoro group, chloro group, bromo group, and iodo group, thio groups such as a methylthio group, ethylthio group, propylthio group, butylthio group, and phenylthio group, sulfamoyl groups such as a methylsulfamoyl group, dimethylsulfamoyl group, ethylsulfamoyl group, diethylsulfamoyl group, propylsulfamoyl group, dipropylsulfamoyl group, butylsulfamoyl group, and dibutylsulfamoyl group, amino groups such as a primary amino group, methylamino group, dimethylamino group, ethylamino group, diethylamino group, propylamino group, dipropylamino group, isopropylamino group, diisopropylamino group, butylamino group, dibutylamino group, and piperidino group, carbamoyl groups such as a methylcarbamoyl group, dimethylcarbamoyl group, ethylcarbamoyl group, diethylcarbamoyl group, propylcarbamoyl group, and dipropylcarbamoyl group, a hydroxy group, a carboxy group, a cyano group, a nitro group, a sulfino group, a sulfo group, and a mesyl group. Note that in these formulas, Z1 and Z2 may be the same or different.

In the formulas of the monomethinecyanine dye and styryl dye, Y11, Y12, and Y31 each represent a carbon atom or hetero atom. Examples of the hetero atom are the atoms in the 15th and 16th columns of the periodic table such as a nitrogen atom, oxygen atom, sulfur atom, selenium atom, and tellurium atom. Note that the carbon atom in each of Y11, Y12, and Y31 may also be an atomic group mainly containing two carbon atoms. Examples are an ethylene group and vinylene group. Also, Y11 and Y12 in the formula of the monomethinecyanine dye may be the same or different.

In the formulas of the monomethinecyanine dye and styryl dye, R11, R12, R31, R32, and R33 each represent an aliphatic hydrocarbon group. Examples of the aliphatic hydrocarbon group are a methyl group, ethyl group, propyl group, isopropyl group, isopropenyl group, 1-propenyl group, 2-propenyl group, butyl group, isobutyl group, sec-butyl group, tert-butyl group, 2-butenyl group, 1,3-butadienyl group, pentyl group, isopentyl group, neopentyl group, tert-pentyl group, 1-methylpentyl group, 2-methylpentyl group, 2-pentenyl group, hexyl group, isohexyl group, 5-methylhexyl group, heptyl group, and octyl group. This aliphatic hydrocarbon group may have one or a plurality of substituent groups similar to those in Z1 to Z3.

Note that R11 and R12 in the formula of the monomethinecyanine dye and R31, R32, and R33 in the formula of the styryl dye may be the same or different. In the formulas of the monomethinecyanine dye and styryl dye, R13 to R16, R34, and R35 each independently represent a hydrogen atom or an appropriate substituent group. Examples of the substituent group are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, 5-methylhexyl group, heptyl group, and octyl group, ether groups such as a methoxy group, trifluoromethoxy group, ethoxy group, propoxy group, butoxy group, tert-butoxy group, pentyloxy group, phenoxy group, and benzoyloxy group, halogen groups such as a fluoro group, chloro group, bromo group, and iodo group, a hydroxy group, a carboxy group, a cyano group, and a nitro group. Note that when Y11, Y12, and Y31 are hetero atoms in the formulas of the monomethinecyanine dye and styryl dye, some or all of R13 to R16 in Z1 and Z2 do not exist, and one or both of R34 and R35 in Z3 do not exist.

In the formula of the azo metal complex, A and A′ represent 5- to 10-membered heterocyclic groups each of which contains one or a plurality of hetero atoms selected from a nitrogen atom, oxygen atom, sulfur atom, selenium atom, and tellurium atom, and which may be the same or different. Examples are a furyl group, thienyl group, pyrrolyl group, pyridyl group, piperidino group, piperidyl group, quinolyl group, and isoxazolyl group. This heterocyclic group may have one or a plurality of substituent groups. Examples are aliphatic hydrocarbon groups such as a methyl group, trifluoromethyl group, ethyl group, propyl group, isopropyl group, butyl group, isobutyl group, sec-butyl group, tert-butyl group, pentyl group, isopentyl group, neopentyl group, tert-pentyl group, 1-methylpentyl group, 2-methylpentyl group, hexyl group, isohexyl group, and 5-methylhexyl group, ester groups such as a methoxycarbonyl group, trifluoromethoxycarbonyl group, ethoxycarbonyl group, propoxycarbonyl group, acetoxy group, trifluoroacetoxy group, and benzoyloxy group, aromatic hydrocarbon groups such as a phenyl group, biphenylyl group, otolyl group, m-tolyl group, p-tolyl group, o-cumenyl group, m-cumenyl group, p-cumenyl group, xylyl group, mesityl group, styryl group, cinnamoyl group, and naphthyl group, a carboxy group, a hydroxy group, a cyano group, and a nitro group.

Note that an azo compound forming the azo-based organic metal complex represented by the formula can be obtained by causing diazonium salt having R21 and R22 or R23 and R24 corresponding to the formula to react with a heterocyclic compound having an active methylene group adjacent to a carbonyl group in the molecule, in accordance with the conventional method. Examples of the heterocyclic compound are an isoxazolone compound, oxazolone compound, thionaphthene compound, pyrazolone compound, barbituric acid compound, hydantoin compound, and rhodanine compound. Y21 and Y22 represent hetero atoms that are selected from the elements in the 16th column of the periodic table, such as an oxygen atom, sulfur atom, selenium atom, and tellurium atom, and may be the same or different.

The azo metal complex represented by the formula is generally used in the form of a metal complex in which one or a plurality of azo metal complexes are oriented around a metal (central atom). Examples of the metal element as the central atom are scandium, yttrium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. Cobalt can be used in one mode of the present invention.

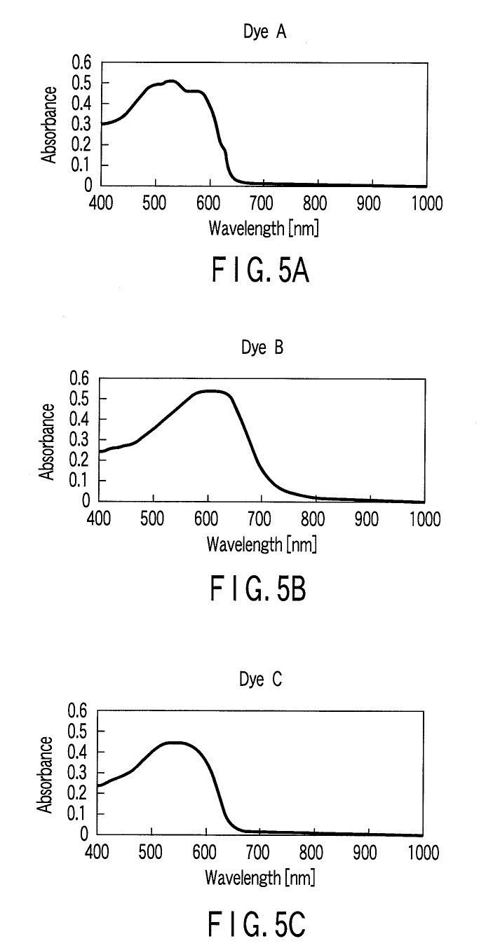

FIG. 5A shows the change in absorbance of dye A to the wavelength of an emitted laser beam. FIG. 5B shows the change in absorbance of dye B to the wavelength of an emitted laser beam. FIG. 5C shows the change in absorbance of dye C to the wavelength of an emitted laser beam.

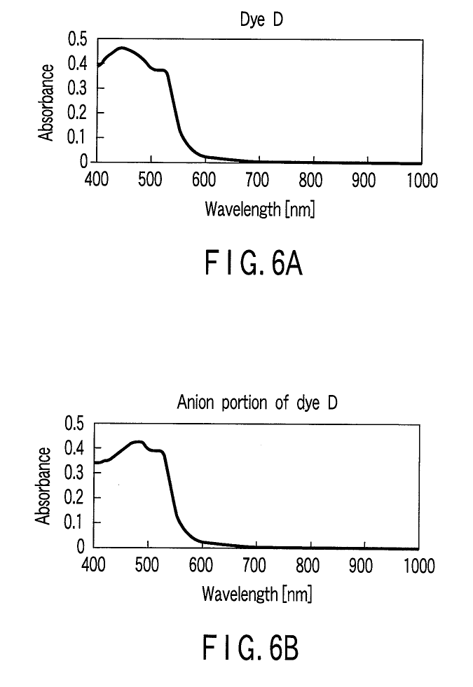

FIG. 6A shows the change in absorbance of dye D to the wavelength of an emitted laser beam. FIG. 6B shows the change in absorbance of the anion portion of dye D to the wavelength of an emitted laser beam. As is evident from the characteristics shown in FIGS. 5A to 6B, maximum absorption wavelength regions of dyes A to D shifted to the long-wavelength side from the recording wavelength (405 nm). The write-once optical disk explained in this embodiment contains the organic dye having the above-mentioned characteristics in the recording film, and is given so-called L-to-H characteristics by which the light reflectance after laser beam irradiation is higher than that before laser beam irradiation. Even when using a short-wavelength laser beam such as a blue laser beam, therefore, the write-once optical disk is superior in storage durability, playback signal-to-noise ratio, and bit error rate, and can perform high-density information recording/playback with performance on a well practical level.

That is, in this write-once optical disk, a maximum absorption wavelength of the recording film containing the organic dye is greater than the wavelength of a recording laser beam. Since this makes it possible to decrease the absorption of short-wavelength light such as ultraviolet radiation, the optical stability and information recording/playback reliability of the optical disk improve.

Also, since the light reflectance is low when information is recorded, no cross write occurs due to reflection and diffusion. Even when information is recorded on adjacent tracks, therefore, it is possible to reduce the deterioration of the playback signal-to-noise ratio and bit error rate. Furthermore, the contrast and resolution of a recording mark can be held high against heat. This facilitates recording sensitivity design.

When a dye having a maximum absorption wavelength region shifted to the short-wavelength side from the recording wavelength (405 nm) is used in the recording film, the write-once optical disk explained in this embodiment is given so-called H-to-L characteristics by which the light reflectance after laser beam irradiation is lower than that before laser beam irradiation. Even when using a short-wavelength laser beam such as a blue laser beam, therefore, the write-once optical disk is superior in, e.g., reflectance, playback signal-to-noise ratio, and bit error rate, and can perform high-density information recording/playback with performance on a well practical level.

That is, in this write-once optical disk, a maximum absorption wavelength of the recording film containing the organic dye is less than the wavelength of a recording laser beam. Since this makes it possible to absorb or more or less reflect short-wavelength light such as ultraviolet radiation, the optical stability and information recording/playback reliability of the optical disk improve. Furthermore, the contrast and resolution of a recording mark can be held high against heat. This facilitates recording sensitivity design.

The azo compound has an aromatic ring. The recording characteristics, storage characteristics, playback stability, and the like can be optimized not only by the structure of the aromatic ring but also by giving various substituent groups to the aromatic ring. This substituent group often increases the playback light resistance but decreases the recording sensitivity as the bulk increases. Accordingly, it is important to select a substituent group that improves both the characteristics. This substituent group also helps increase the solubility in a solvent.

Unlike the recording mechanism of the conventional dye-based information recording medium (the recording laser wavelength is greater than 620 nm), the recording mechanism of short-wavelength laser recording (the recording wavelength is, e.g., 405 nm) according to the present invention is not a physical change in substrate or dye film volume. Since light is absorbed at the laser recording wavelength, the orientation of dye molecules in the recording layer or the conformation in the dye molecule gradually changes during playback due to heat or light when the dye is irradiated with a laser weaker than that during recording. However, the bulky substituent group existing in the dye molecule presumably has the effect of suppressing these changes. This is the reason why the bulky substituent group helps increase the playback light resistance.

The bulky substituent group herein mentioned is a substituent group having three or more carbon atoms substituting the aromatic ring in the dye molecule. Examples are an n-propyl group, isopropyl group, n-butyl group, 1-methylpropyl group, 2-methylpropyl group, n-pentyl group, 1-ethylpropyl group, 1-phenylpropyl group, 1-methylbutyl group, 2-methylbutyl group, 3-methylbutyl group, 1,1-dimethylpropyl group, 1,1-diphenylmethyl group, 1,2-dimethylpropyl group, 2,2-dimethylpropyl group, cyclopentyl group, n-hexyl group, 1-methylpentyl group, 2-methylpentyl group, 3-methylpentyl group, 4-methylpentyl group, 1,1-dimethylbutyl group, 1,2-dimethylbutyl group, 1,3-dimethylbutyl group, 2,2-dimethylbutyl group, 2,3-dimethylbutyl group, 3,3-dimethylbutyl group, 1-ethylbutyl group, 2-ethylbutyl group, cyclohexyl group, and phenyl group. These substituent groups may also contain atoms other than carbon. Examples are oxygen, sulfur, nitrogen, silicon, fluorine, bromine, chlorine, and iodine.

Formulas 1 and 2 below indicate two types of formulas of azo dyes used in this embodiment.

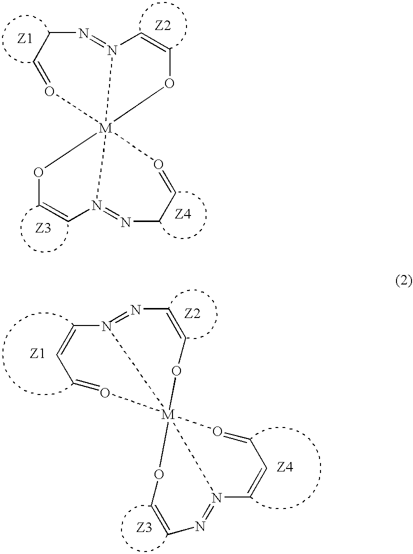

In the above formulas, an aromatic ring enters at least one of Z1 to Z4, and the aromatic rings in Z1 to Z4 may be different from each other. This aromatic ring is formed by bonding cyclic nuclei such as an imidazoline ring, imidazole ring, benzoimidazole ring, a-naphthoimidazole ring, R-naphthoimidazole ring, indole ring, isoindole ring, indolenine ring, isoindolenine ring, benzoindolenine ring, pyridinoindolenine ring, oxazoline ring, oxazole ring, isoxazole ring, benzoxazole ring, pyridinoxazole ring, β-naphthoxazole ring, α-naphthoxazole ring, selenazoline ring, selenazole ring, benzoselenazole ring, α-naphthoselenazole ring, β-naphthoselenazole ring, thiazoline ring, thiazole ring, isothiazole ring, benzothiazole ring, α-naphthothiazole ring, β-naphthothiazole ring, tellurazoline ring, tellurazole ring, benzotellurazole ring, α-naphthotellurazole ring, β-naphthotellurazole ring, acridine ring, anthracene ring, isoquinoline ring, isopyrrole ring, imidanoxaline ring, indandione ring, indazole ring, indaline ring, oxadiazole ring, carbazole ring, xanthene ring, quinazoline ring, quinoxaline ring, quinoline ring, chroman ring, cyclohexanedione ring, cyclopentanedione ring, cinnoline ring, thiodiazole ring, thioxazolidone ring, thiophene ring, thionaphthene ring, thiobarbituric acid ring, thiohydantoin ring, tetrazole ring, triazine ring, naphthalene ring, naphthyridine ring, barbituric acid ring, piperazine ring, pyrazine ring, pyrazole ring, pyrazoline ring, pyrazolidine ring, pyrazolone ring, pyran ring, pyridine ring, pyridazine ring, pyridone ring, pyrimidine ring, pyrylium ring, pyrrolidine ring, pyrroline ring, pyrrole ring, phenazine ring, phenanthridine ring, phenanthrene ring, phenanthroline ring, phthalazine ring, pteridine ring, furazane ring, furan ring, purine ring, benzene ring, benzoxazine ring, benzopyran ring, morpholine ring, and rhodanine ring.

In the organic dye having the dye portion (cation portion) and anion portion, a cyanine dye, styryl dye, monomethinecyanine dye, or azo dye can be used as the dye material portion although not shown.

### Example 1

A transparent resin substrate having a diameter of 120 mm and a thickness of 0.6 mm and made of, e.g., polycarbonate was prepared. This transparent resin substrate had concentric or spiral grooves and lands on its surface. Then, a 1.2-wt % 2,2,3,3-tetrafluoro-1propanol (TFP) solution of an, organic dye represented by formula (D1) was prepared.

Subsequently, an organic dye layer was formed by coating the transparent resin substrate with the TFP solution by spin coating. The thickness of the organic dye layer from the groove bottom was 60 nm after coating. A 100-nm-thick light-reflecting layer made of an Ag alloy was stacked on the obtained organic dye layer by sputtering, thereby obtaining a recording layer in which the organic dye layer and light-reflecting layer were stacked.

In addition, the light-reflecting layer was spin-coated with a UV-curing resin, and a 0.60-nm-thick transparent resin substrate 18 was adhered, thereby obtaining a single-layer, write-once information recording medium. A dye represented by formula (D1) was an organic metal complex, and had a maximum absorption wavelength of 423 nm.

Optimum maximum recording powers were 7.6, 9.5, and 12.0 mW at a one-times velocity, two-times velocity, and four-times velocity, respectively. In this case, Pw2×/Pw1×=1.25. The optimum maximum recording powers at the individual linear velocities were described beforehand as recording parameters in the system lead-in area. Playback signal evaluation experiments were conducted by using the information recording medium (single-layer R evaluation disk) manufactured as described above.

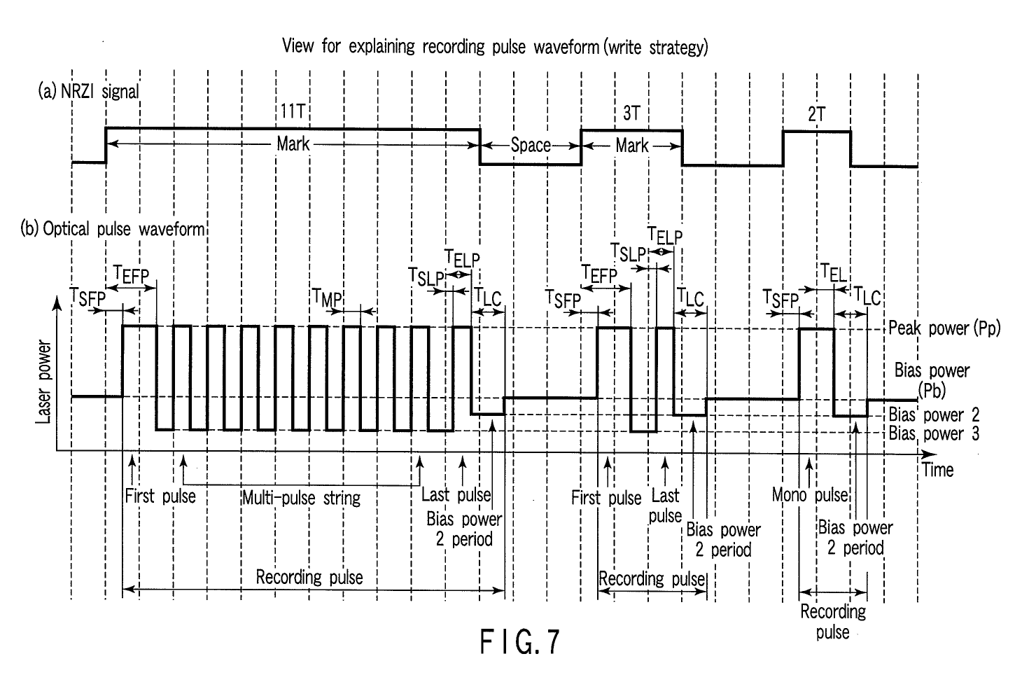

An ODU-1000 optical disk evaluation apparatus manufactured by PULSTEC was used in the evaluation. The apparatus has a laser wavelength of 405 nm and an NA of 0.65. The playback linear velocity was set at 6.61 m/s. Assuming that a playback linear velocity of 6.61 m/s was a one-times velocity, the recording velocity was set at 6.61 m/s as a one-times velocity, 13.22 m/s as a two-times velocity, and 26.44 m/s as a four-times velocity. A recording signal was 8/12-modulated random data. Information was recorded by using a laser waveform including a recording power (peak power) and two types of bias powers 1 and 2 as shown in FIG. 7. The recording conditions will be described below.

Explanation of Recording Conditions (Write Strategy Information)

A recording waveform (recording exposure conditions) used to check the optimum recording power for the standard velocity and two-times velocity will be explained with reference to FIG. 7. Recording exposure levels are four levels, i.e., a recording power (peak power), bias power 1, bias power 2, and bias power 3, and modulation is performed in the form of a multi-pulse between the recording power (peak power) and bias power 3 when forming a long recording mark 9 (of 4T or more). In this embodiment, a minimum mark length with respect to a channel bit length T is 2T. When recording this 2T minimum mark, as shown in FIG. 7, a write pulse on the recording power (peak power) level is used after bias power 1, and bias power 2 is applied once immediately after this write pulse. When recording a recording mark 9 having a length of 3T, two write pulses, i.e., a first pulse and last pulse on the recording power (peak power) level that comes after bias power 1 are exposed, and bias power 2 is applied once. When recording a recording mark 9 having a length of 4T or more, bias power 2 is applied after exposure is performed using a multi-pulse and last pulse.

Referring to FIG. 7, the vertical broken lines indicate a channel clock period (T). When recording a 2T minimum mark, the waveform rises from a position that lags the clock edge by T_{SFP}, and falls in a position that lags, by T_{ELP}, an edge one clock after that. A period in which bias power 2 is applied immediately after that is defined as T_{LC}. When the H format is used, the values of T_{SFP}, T_{ELP}, and T_{LC} are recorded in physical format information PFI in a control data zone CDZ.

When forming a long recording mark of 3T or more, the waveform rises in a position that lags the clock edge by T_{SFP}, and ends with a last pulse. Bias power 2 is applied in the period T_{LC} immediately after the last pulse. The time differences of the rise and fall times of the last pulse from the clock edge are defined by T_{SLP} and T_{ELP}. Also, the time measured from the clock edge to the fall timing of the first pulse is defined by T_{EFP}, and the interval of one multi-pulse is defined by T_{MP}.

The intervals of T_{ELP}-T_{SFP}, T_{MP}, T_{ELP}-T_{SLP}, and T_{LC} are defined by half-widths with respect to maximum values. In this embodiment, the set ranges of these parameters are indicated by

0.25T≦TSFP≦1.50T (eq. 01)

0.00T≦TELP≦1.00T (eq. 02)

1.00T≦TEFP≦1.75T (eq. 03)

−0.10T≦TSLP≦1.00T (eq. 04)

0.00T≦TLC≦1.00T (eq. 05)

0.15T≦TMP≦0.75T (eq. 06)

Furthermore, in this embodiment, the values of the above parameters can be changed in accordance with the length (mark length) of a recording mark and the space lengths (leading/trailing space lengths) immediately before and after the recording mark.

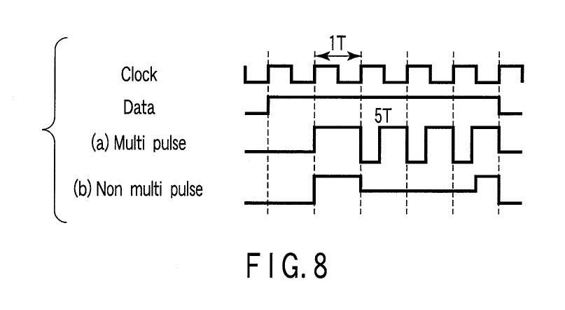

If the multi-pulse write strategy as described above is used when recording information at the two-times velocity or higher, the clock time decreases as the transfer rate increases, and the pulse width becomes less than the total rise and fall time of the laser when actual light emission pulses are observed. This makes it difficult to stably output an accurate laser power. Especially when recording information at a high linear velocity, therefore, it is possible to use a one-pulse recording method instead of the multi-pulse method. As a recording strategy to be used in this case, it is possible to use a waveform by which a portion between the first pulse and last pulse of the multi-pulse described above is output by power (Pw2) slightly lower than this recording power (Pw1). FIG. 8 shows an example. Referring to FIG. 8, (a) indicates the multi-pulse method used at the one-times velocity or two-times velocity described above, and (b) indicates a non-multi-pulse method for use in highlinear-velocity recording. In this embodiment, similar to the multi-pulse method indicated by (a), it is possible to change the values of the parameters such as the pulse rise and fall times in accordance with the length (mark length) of a recording mark and the space lengths (leading/trailing space lengths) immediate before and after the recording mark.

When information was recorded with this recording power, the values of SbER were 4.2×10⁻⁸, 8.2×10⁻⁷, and 1.3×10⁻⁵ at the one-times velocity, two-times velocity, and four-times velocity, respectively. That is, it was possible to obtain favorable recording characteristics from 1× to 4×.

Since the laser wavelength λ was 405 nm and the NA was 0.65, substituting the 1× linear recording velocity into X of λ/(X*NA) yields

λ/(X*NA)=405 nm/(6.61 m/s*0.65)=9.43×10⁻⁸

Also, similarly substituting the 4× linear recording velocity into X of λ/(X*NA) yields

λ/(X*NA)=405 nm/(26.44 m/s*0.65)=2.36×10⁻⁸

This demonstrates that recording is possible at least within the range of 9.5×10⁻⁸≧λ/(X*NA)≧2.4×10⁻⁸.

### Comparative Example

An information recording medium was manufactured by using a dye represented by formula 3 below, and information was recorded.

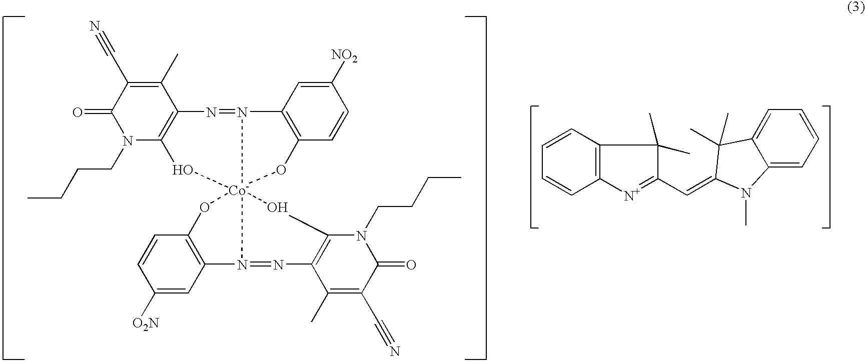

The dye represented by formula 3 included an anion portion made of an organic metal complex and a cation portion made of cyanine, and had a maximum absorption wavelength of 422 nm.

Optimum recording powers were 6.3, 8.6, and 11.8 mW at 1×, 2×, and 4×, respectively. In this case, Pw2×/Pw1×=1.37.

The values of SbER when recording information at the above recording powers were 7.0×10⁻⁸, 3.9×10⁻⁵, and 1.0×10⁻³ at 1×, 2×, and 4×, respectively. That is, favorable recording characteristics were obtained up to 2×, but the SbER was smaller than 5×10⁻⁵ as a target value at 4×.

Since the laser wavelength λ was 405 nm and the NA was 0.65, substituting the 1× linear recording velocity into X of λ/(X*NA) yields

λ/(X*NA)=405 nm/(6.61 m/s*0.65)=9.43×10⁻⁸

Also, similarly substituting the 2× linear recording velocity into X of λ/(X*NA) yields

λ/(X*NA)=405 nm/(13.22 m/s*0.65)=4.71×10⁻⁸

This demonstrates that recording is possible at least within the range of 9.5×10⁻⁸≧λ/(X*NA)≧4.6×10⁻⁸.

Note that the present invention is not limited to the above embodiments, and can be variously modified without departing from the spirit and scope of the invention when practiced at present or in the future on the basis of techniques usable at that time. For example, the present invention can also be practiced not only on a single-layer disk or dual-layer disk but also on an optical disk having three or more recording layers that will be put into practice in the future.

Also, the individual embodiments may also be appropriately combined as much as possible when practiced. In this case, the combined effects can be obtained. Furthermore, these embodiments include inventions in various stages, so various inventions can be extracted by properly combining a plurality of disclosed constituent elements. For example, even when some of all the constituent elements disclosed in the embodiments are deleted, an arrangement from which these constituent elements are deleted can be extracted as an invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording medium comprising a transparent resin substrate on which grooves and lands having a concentric shape or a spiral shape are formed, and a recording layer formed on the grooves and the lands of the transparent resin substrate, the information recording medium being configured to record and play back information by using a laser at not more than 450 nm, wherein the recording medium is configured such that information recording is performed to substantially satisfy the expression
9.5×10⁻⁸≧λ/(X*NA)≧4.6×10⁻⁸,
where X is a linear recording velocity, λ is the laser wavelength, and NA is a numerical aperture.

2. A medium according to claim 1, wherein the recording medium is configured such that information recording is performed to substantially satisfy the expression
9.5×10⁻⁸≧λ/(X*NA)≧2.4×10⁻⁸
where X is a linear recording velocity, λ is the laser wavelength, and NA is a numerical aperture.

3. A medium according to claim 1, wherein the recording layer comprises an organic dye layer, and a light-reflecting layer formed on the recording layer.

4. A medium according to claim 3, wherein the organic dye layer comprises an organic metal complex.

5. A medium according to claim 4, wherein the organic metal complex comprises an azo organic metal complex.

6. A medium according to claim 3, wherein a maximum absorption wavelength of the organic dye layer before recording is substantially within a range of −10 to +50 nm from a recording laser wavelength.

7. A medium according to claim 1, wherein the medium is configured such that a relationship between a maximum value (Pw1×) of recording power when recording is performed at a standard velocity and a maximum value (Pw2×) of recording power when recording is performed at a two-times velocity is substantially represented by the expression: Pw2×/Pw1×<1.35.

8. A medium according to claim 1, further comprising a predetermined area containing recording parameters, wherein information concerning a maximum value (Pw1×) of recording power when recording is performed at a standard velocity and a maximum value (Pw2×) of recording power when recording is performed at a two-times velocity is described in the predetermined area.
